(19) United States
(12) Patent Application Publication
(10) Pub. No.: US 2015/0027608 A1
(43) Pub. Date: Jan. 29, 2015

(54) PNEUMATIC TIRE

(71) Applicant: TOYO TIRE & RUBBER CO., LTD., Osaka-shi (JP)

(72) Inventor: Souichi Takahashi, Osaka-shi (JP)

(21) Appl. No.: 14/446,128

(22) Filed: Jul. 29, 2014

(30) Foreign Application Priority Data
Jul. 29, 2013 (JP) 2013-156596

(51) Int. Cl. B60C 9/30; B60C 9/20

(52) U.S. Cl. CPC B60C 9/30; B60C 9/20
USPC 152/455

(57) ABSTRACT

A pneumatic tire has a toroidal carcass layer, a belt layer, and a first fiber reinforcing layer which is arranged so as to cover both end portions of the belt layer, wherein a reinforcing rubber layer is arranged between the first fiber reinforcing layer and the belt layer at a shoulder portion at one side at which the shoulder portion is positioned at an inner side of the vehicle at the time of installing the tire, and a second fiber reinforcing layer is arranged in adjacent to the outer side or the inner side of the first fiber reinforcing layer at a shoulder portion at the other side at which the shoulder portion is positioned at the outer side of the vehicle, and wherein a peeling strength of the reinforcing rubber layer is higher than a peeling strength of the belt layer and the first fiber reinforcing layer.

### BACKGROUND OF THE INVENTION

1. Field of the Invention

The present invention relates to a pneumatic tire provided with a carcass layer which is provided between a pair of bead portions, a belt layer which is arranged at an outer side in a tire diametrical direction of the carcass layer, and a fiber reinforcing layer which is arranged so as to cover both end portions of the belt layer at an outer side in the tire diametrical direction of the belt layer.

2. Description of the Related Art

Conventionally, there has been known a pneumatic tire in which a fiber reinforcing layer is arranged at an outer side in a tire diametrical diction of a belt layer in a tread portion. As the fiber reinforcing layer, there is generally employed a structure which is formed by winding an organic fiber cord such as nylon or aramid substantially in a tire circumferential direction.

There is a case that the fiber reinforcing layer is arranged so as to cover a whole width of the belt layer, or a case that the fiber reinforcing layer is arranged so as to cover only both end portions of the belt layer. However, the fiber reinforcing layer is arranged so as to cover at least both end portions of the belt layer, for the purpose of improving a steering stability and a durability.

In the following patent document 1, there is described a pneumatic tire in which a fiber reinforcing layer is arranged at a shoulder portion which is positioned at an inner side of a vehicle, for the purpose of improving a steering stability in a high speed area and suppressing a flat spot effect. However, since the fiber reinforcing layer is arranged only at the shoulder portion at the inner side of the vehicle, a steering stability in a high load area and a high speed durability in an outer side of the vehicle are deteriorated.

Further, in the following patent document 2, there is described a pneumatic tire in which a fiber reinforcing layer is arranged only at a shoulder portion which is positioned at an outer side of a vehicle, for the purpose of preventing an irregular wear at the shoulder portion without deteriorating a ride quality. However, since the fiber reinforcing layer is arranged only at the shoulder portion at the outer side of the vehicle, a high speed durability at an inner side of the vehicle is deteriorated.

Further, in the following patent document 3, there is described a pneumatic tire in which rubber strips covering terminal ends of a belt layer are inserted respectively between a fiber reinforcing layer and both end portions of the belt layer, for the purpose of improving a belt durability in a high load area. However, since the rubber strip is arranged between the fiber reinforcing layer and the belt layer at the shoulder portions at both sides, a steering stability is deteriorated.

### PRIOR ART DOCUMENTS

### Patent Document

Patent Document 1: JP-A-3-96406
Patent Document 2: JP-A-11-321231
Patent Document 3: JP-A-2008-6890

### SUMMARY OF THE INVENTION

The present invention is made by taking the actual conditions mentioned above into consideration, and an object of the present invention is to provide a pneumatic tire which achieves both a steering stability and a durability.

### Means for Solving the Problem

To achieve the above object, a pneumatic tire in accordance with the present invention comprises: a toroidal carcass layer which is provided between a pair of bead portions; a belt layer which is arranged at an outer side in a tire diametrical direction of the carcass layer; and a first fiber reinforcing layer which is arranged so as to cover both end portions of the belt layer at an outer side in the tire diametrical direction of the belt layer, wherein a reinforcing rubber layer is arranged between the first fiber reinforcing layer and the belt layer at a shoulder portion at one side at which the shoulder portion is positioned at an inner side of the vehicle at the time of installing the tire, and a second fiber reinforcing layer is arranged in adjacent to the outer side or the inner side in the tire diametrical direction of the first fiber reinforcing layer at a shoulder portion at the other side at which the shoulder portion is positioned at the outer side of the vehicle, and wherein a peeling strength of the reinforcing rubber layer is higher than a peeling strength of the belt layer and the first fiber reinforcing layer.

A description will be given of an operation and effect of the pneumatic tire according to the structure mentioned above. In the pneumatic tire according to the present invention, since the reinforcing rubber layer having the higher peeling strength (being harder to be peeled) than the belt layer and the first fiber reinforcing layer is arranged between the first fiber reinforcing layer and the belt layer, at the shoulder portion at one side at which the shoulder portion is positioned at the inner side of the vehicle at the time of installing the tire, it is possible to suppress a separation at the shoulder portion at the inner side of the vehicle, and it is possible to improve a durability. Further, since the second fiber reinforcing layer is arranged in adjacent to the outer side or the inner side in the tire diametrical direction of the first fiber reinforcing layer, at the shoulder portion at the other side at which the shoulder portion is positioned at the outer side of the vehicle at the time of installing the tire, it is possible to improve a steering stability particularly in a high load area. As a result, the pneumatic tire according to the present invention can achieve both the steering stability and the durability.

In the pneumatic tire in accordance with the present invention, it is preferable that a width of the reinforcing rubber layer is equal to or less than one third of a half width of the first fiber reinforcing layer based on a tire equator.

The steering stability is deteriorated if the width of the reinforcing rubber layer becomes too large in relation to the tire whole width; however, when the width of the reinforcing rubber layer is within the range, it is possible to well achieve both the steering stability and the durability without deteriorating the steering stability.

In the pneumatic tire in accordance with the present invention, it is preferable that a width of the second fiber reinforcing layer is equal to or less than one third of a half width of the first fiber reinforcing layer based on a tire equator.

A grounding pressure difference between the inner side of the vehicle and the outer side of the vehicle becomes large and the steering stability is deteriorated if the width of the second fiber reinforcing layer becomes too large in relation to the tire whole width; however, when the width of the second fiber reinforcing layer is within the range, it is possible to well achieve both the steering stability and the durability without deteriorating the steering stability.

In the pneumatic tire in accordance with the present invention, it is preferable that the end number of the second fiber reinforcing layer is equal to or more than the end number of the first fiber reinforcing layer.

It is possible to more improve the steering stability by increasing the end number of the second fiber reinforcing layer which is arranged at the shoulder portion at the outer side of the vehicle.

### BRIEF DESCRIPTION OF THE DRAWINGS

FIG. 1 is a cross sectional view of a tire meridian and shows an example of a pneumatic tire according to the present invention;

FIG. 2 is a cross sectional view schematically showing a tread portion

FIG. 3 is a cross sectional view schematically showing a tread portion according to the other embodiment;

FIG. 4 is a cross sectional view schematically showing a tread portion according to the other embodiment;

FIG. 5 is a cross sectional view schematically showing a tread portion according to the other embodiment; and

FIG. 6 is a cross sectional view schematically showing a tread portion according to the other embodiment.

### DETAILED DESCRIPTION OF THE PREFERRED EMBODIMENTS

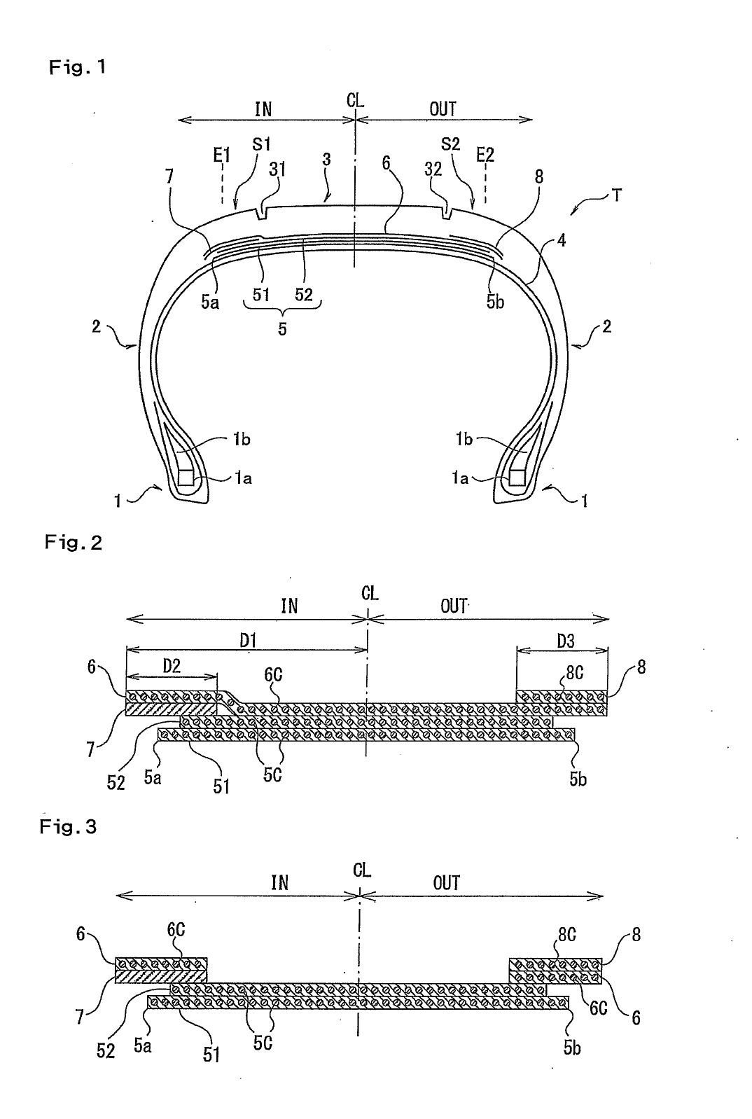

A description will be given below of embodiments according to the present invention with reference to the accompanying drawings. FIG. 1 is a cross sectional view of a tire meridian and schematically shows an example of a pneumatic tire according to the present invention, and reference symbol CL denotes a tire equator. FIG. 2 is a cross sectional view schematically showing a tread portion of the tire; however, cords in the drawing are conceptually described, and an actual arrangement pitch is denser.

A pneumatic tire T is a pneumatic tire provided with a pair of bead portions 1, side wall portions 2 which are extended outward in a tire diametrical direction from the bead portions 1, a tread portion 3 which is connected to an outer end in the tire diametrical direction of each of the side wall portions 2, a toroidal carcass layer 4 which is provided between a pair of bead portions 1, a belt layer 5 which is arranged at an outer side in the tire diametrical direction of the carcass layer 4, and a first fiber reinforcing layer 6 which is arranged so as to cover both end portions 5a and 5b of the belt layer 5 at an outer side in the tire diametrical direction of the belt layer 5.

Each of a pair of bead portions 1 is provided with an annular bead core 1a, and a bead filler 1b which is arranged at an outer side in the tire diametrical direction of the bead core 1a and is made of a hard rubber. The carcass layer 4 is constructed by a carcass ply which is formed by arranging a carcass cord extending in a direction which is approximately orthogonal to a tire circumferential direction, and is folded back so that both end portions thereof sandwich the bead core 1a and the bead filler 1b. The carcass cord preferably employs an organic fiber such as polyester, rayon, nylon and aramid, and a steel fiber.

The belt layer 5 is constructed by a plurality of layers (two layers in the present embodiment) of belt plies 51 and 52 formed by arranging belt cords 5C extending so as to be inclined to the tire circumferential direction, and the respective belt plies 51 and 52 are laminated so that the belt cords 5C intersect in inverse directions to each other. In the present embodiment, a width in a tire width direction of the belt ply 51 is wider than the belt ply 52. Both end portions 5a and 5b of the belt layer 5 in the present invention are both end portions of the belt ply having a maximum width in a plurality of belt plies constructing the belt layer 5, and are both end portions of the belt ply 51 in the present embodiment. The belt plies 51 and 52 are formed by covering a plurality of belt cords 5C arranged in parallel with a belt topping rubber from both sides. The organic fiber mentioned above can be employed as the belt cord 5C; however, the steel fiber is preferably employed for enhancing a rigidity in a circumferential direction.

The first fiber reinforcing layer 6 has a plurality of reinforcing cords 6C which extend substantially in parallel to the tire circumferential direction. The first fiber reinforcing layer 6 covers a whole of the belt layer 5 including both end portions 5a and 5b of the belt layer 5. The first fiber reinforcing layer 6 is formed by spirally winding, around a molding drum, a band-like member which is formed by covering the reinforcing cord 6C aligned with a reinforcing topping rubber. The organic fiber such as the polyester, the rayon, the nylon and the aramid is preferably employed as the reinforcing cord 6C.

At least two main grooves 31 and 32 extending along the tire circumferential direction are formed on a tread surface of the pneumatic tire T according to the present invention. In the present invention, shoulder portions S1 and S2 are set to an area which is at an outer side in a tire width direction than the main grooves 31 and 32 positioned at an outermost side in the tire width direction, and is at an inner side in the tire width direction than grounding ends E1 and E2. The grounding ends E1 and E2 indicate an outermost position in a tire axial direction of a grounding surface which comes into contact with a road surface in the case that the tire is vertically put on a flat road surface in a state in which the tire is assembled in a normal rim and a normal internal pressure is charged, and a normal load is applied.

The pneumatic tire T according to the present invention is a tire whose installing direction is designated, and the installing direction is designated so that an outside area OUT is directed to an outer side of the vehicle and an inside area IN is directed to an inner side of the vehicle, when the tire is installed to the vehicle. The installing direction to the vehicle is designated, for example, by attaching a display indicating to the side wall portion 2 of the tire whether the tire is installed at the inner side of the vehicle or the outer side of the vehicle.

In the pneumatic tire T according to the present invention, a reinforcing rubber layer 7 is arranged between the first fiber reinforcing layer 6 and the belt layer 5 at the shoulder portion S1 at one side at which the shoulder portion S1 is positioned at the inner side of the vehicle at the time of installing the tire, and a second fiber reinforcing layer 8 is arranged in adjacent to the outer side or the inner side in the tire diametrical direction of the first fiber reinforcing layer 6 at the shoulder portion S2 at the other side at which the shoulder portion S2 is positioned at the outer side of the vehicle. In the present embodiment, there is shown an example in which the second fiber reinforcing layer 8 is arranged in adjacent to the outer side in the tire diametrical direction of the first fiber reinforcing layer 6.

In the pneumatic tire T according to the present invention, since the reinforcing rubber layer 7 having a higher peeling strength than the belt layer 5 and the first fiber reinforcing layer 6 is arranged between the first fiber reinforcing layer 6 and the belt layer 5, at the shoulder portion S1 at one side which is positioned at the inner side of the vehicle at the time of installing the tire, it is possible to suppress a separation at the shoulder portion S1 at the inner side of the vehicle, and it is possible to improve a durability. Further, since the second fiber reinforcing layer 8 is arranged in adjacent to the outer side or the inner side in the tire diametrical direction of the first fiber reinforcing layer 6, at the shoulder portion S2 at the other side which is positioned at the outer side of the vehicle at the time of installing the tire, it is possible to improve a steering stability particularly in a high load area. Further, the pneumatic tire T according to the present invention is particularly useful in the case that the tire is installed to the vehicle in a state in which a negative camber is attached.

The reinforcing rubber layer 7 is constructed by a rubber having a tape shape or a sheet shape. In the reinforcing rubber layer 7, a peeling strength is higher than a peeling strength of the belt layer 5 and the first fiber reinforcing layer 6. Since the peeling strength of the reinforcing rubber layer 7 is higher than the peeling strength of the belt layer 5 and the first fiber reinforcing layer 6, it is possible to suppress the separation between the belt layer 5 and the first fiber reinforcing layer 6 at the shoulder portion S1.

The peeling strength of the present invention is a value which is measured according to JIS K-6256-2, and the greater value of the peeling strength indicates that the peeling is difficult to occur. Further, since the reinforcing rubber layer 7 is constructed only by the rubber, the peeling strength of the reinforcing rubber layer 7 indicates the peeling strength of the rubber to be constructed. In the same manner, since the belt layer 5 and the first fiber reinforcing layer 6 are constructed by covering the cord with the topping rubber as mentioned above, the peeling strengths of the belt layer 5 and the first fiber reinforcing layer 6 indicate the peeling strengths of the topping rubbers.

In the light of improvement of a durability, an outer end in the tire width direction of the reinforcing rubber layer 7 and an outer end in the tire width direction of the first fiber reinforcing layer 6 are preferably within ±3 mm area, and more preferably coincide with each other. A width D2 of the reinforcing rubber layer 7 is preferably equal to or more than a width of the shoulder portion S1 at least, in the light of improvement of the durability. Further, the width D2 of the reinforcing rubber layer 7 is preferably equal to or less than one third of a half width D1 of the first fiber reinforcing layer 6 based on a tire equator CL, and more preferably equal to or less than one fourth. In the case that the width D2 of the reinforcing rubber layer 7 is greater than one third of the half width D1 of the first fiber reinforcing layer 6, a rate of the reinforcing rubber layer 7 in relation to a whole of the tire becomes larger, thereby causing a reduction of a cornering power and further a deterioration of the steering stability.

The second fiber reinforcing layer 8 has a plurality of reinforcing cords 8C which extend substantially in parallel to the tire circumferential direction. The second fiber reinforcing layer 8 according to the present embodiment has approximately the same structure as the first fiber reinforcing layer 6.

In the light of improvement of the durability, an outer end in the tire width direction of the second fiber reinforcing layer 8 and an outer end in the tire width direction of the first fiber reinforcing layer 6 are preferably within ±3 mm area, and more preferably coincide with each other. A width D3 of the second fiber reinforcing layer 8 is preferably equal to or more than a width of the shoulder portion S2 at least, in the light of improvement of a steering stability in a high load area. Further, the width D3 of the second fiber reinforcing layer 8 is preferably equal to or less than one third of the half width D1 of the first fiber reinforcing layer 6 based on the tire equator CL, and more preferably equal to or less than one fourth. In the case that the width D3 of the second fiber reinforcing layer 8 is greater than one third of the half width D1 of the first fiber reinforcing layer 6, a difference from the width D2 of the reinforcing rubber layer 7 becomes larger and a grounding pressure dispersion is deteriorated. Accordingly, the steering stability is deteriorated.

A tire thickness at the grounding end E2 of the shoulder portion S2 is preferably between 85 and 115% of the tire thickness in the grounding end E1 of the shoulder portion S1, and more preferably between 90 and 110%. As a result, it is possible to suppress deterioration of the grounding pressure dispersion. In the light of making the tire thickness at the grounding end E1 and the tire thickness at the grounding end E2 uniform as much as possible, the thickness of the second fiber reinforcing layer 8 is preferably between 85 and 115% of the thickness of the reinforcing rubber layer 7, and more preferably between 90 and 110%. Further, in the light of making the tire thickness at the grounding end E1 and the tire thickness at the grounding end E2 uniform as much as possible, the laminating number at the grounding end E1 is preferably equal to the laminating number at the grounding end E2 such as the present invention.

The pneumatic tire according to the present invention is the same as the general pneumatic tire except provision of the reinforcing rubber layer 7 and the second fiber reinforcing layer 8 as mentioned above, and the present invention can employ the conventionally known materials, shapes and structures.

### Other Embodiments

(1) In the embodiment mentioned above, the first fiber reinforcing layer 6 is arranged so as to cover a whole width of the belt layer 5; however, the first fiber reinforcing layer 6 may be arranged so as to cover only both ends 5a and 5b of the belt layer 5 as shown in FIG. 3.

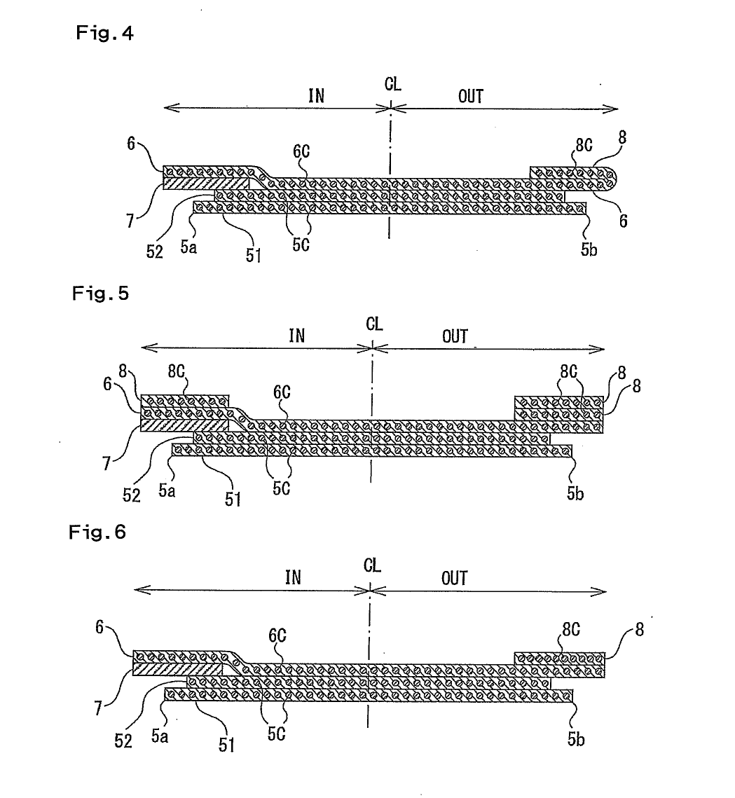

(2) In the embodiment mentioned above, the second fiber reinforcing layer 8 is shown so as to be separated from the first fiber reinforcing layer 6; however, the second fiber reinforcing layer 8 and the first fiber reinforcing layer 6 may be integrally constructed by folding back one fiber reinforcing layer and superposing it, as shown in FIG. 4.

(3) The second fiber reinforcing layer 8 is not limited to one, but may be arranged so that a plurality of layers are superposed. At this time, in the light of suppression of deterioration in the grounding pressure dispersion, the second fiber reinforcing layer 8 is preferably added to the shoulder portion S1 in addition to the shoulder portion S2, as shown in FIG. 5. It is possible to improve the durability and the steering stability by adding the second fiber reinforcing layer 8 to the shoulder portions S1 and S2 at both sides.

(4) In the embodiment mentioned above, the second fiber reinforcing layer 8 is set to approximately the same structure as the first fiber reinforcing layer 6; however, the end number (the cord number per unit width) of the second fiber reinforcing layer 8 is preferably equal to or more than the end number of the first fiber reinforcing layer 6, as shown in FIG. 6. It is possible to more improve the steering stability by increasing the end number of the second fiber reinforcing layer 8 which is arranged at the shoulder portion S2 at the outer side of the vehicle.

### EXAMPLES

A description will be given of examples which concretely show the structure and the effect of the present invention. An evaluation of each of performances of the tire was carried out as follows. A size of the tire supplied to a test was 225/40R18, and was installed to a rim having a rim size defined in JATMA.

(1) High Speed Durability

The load at the maximum load capacity time was applied to the tire, the speed was increased 10 km/h every 10 minutes in a state in which the camber angle 2 degrees is attached (room temperature 35° C.), and the speed in the case that a failure is generated due to the separation in the periphery of the belt end was measured. The evaluation was made by an index number with a result of the conventional example being set to 100, and the greater numerical value indicates the more excellent high speed durability.

(2) Steering Stability

A straight traveling stability, a lane change performance and a cornering performance on a dry road surface were evaluated with a feeling test by two divers. The evaluation was made by an index number with a result of the conventional example being set to 4, and the greater numerical value indicates the more excellent steering stability.

In the conventional example, the second fiber reinforcing layer was arranged in each of the shoulder portions at both sides, and the reinforcing rubber layer according to the present invention was not provided. In an example 1, the reinforcing rubber layer was arranged in place of the second fiber reinforcing layer at the shoulder portion at the inner side of the vehicle, in comparison with the conventional example (refer to FIG. 2). In an example 2, the second fiber reinforcing layer was further arranged at both sides in comparison with the example 1 (refer to FIG. 5). In an example 3, the end number of the second fiber reinforcing layer was increased in comparison with the example 1 (refer to FIG. 6). In a comparative example 1, the reinforcing rubber layer and the second fiber reinforcing layer were reversely arranged in comparison with the example 1. In a comparative example 2, the peeling strength of the reinforcing rubber layer was made lower in comparison with the example 1. In a comparative example 3, the width of the reinforcing rubber layer was widened in comparison with the example 1. In a comparative example 4, the second fiber reinforcing layer was not arranged in comparison with the example 1.

The structure of each of the examples is shown in Table 1 together with the results of evaluation. In Table 1, the peeling strength of the reinforcing rubber layer is a value measured by producing test pieces and carrying out the peeling test according to JIS K-6256-2, and is shown by the index number in the case that the peeling strength of the belt layer and the first fiber reinforcing layer is set to 100. In Table 1, “In” in the arrangement of the reinforcing rubber layer indicates the arrangement of the reinforcing rubber layer at the shoulder portion positioned at the inner side of the vehicle at the tire installing time, and “Out” indicates the arrangement of the reinforcing rubber layer at the shoulder portion positioned at the outer side of the vehicle at the tire installing time. In Table 1, the width (D2) of the reinforcing rubber layer is shown by a rate in the case that the half width (D1) of the first fiber reinforcing layer is set to 100. The arrangement and a width (D3) of the second fiber reinforcing layer are the same as the arrangement and the width (D2) of the reinforcing rubber layer. The end number of the first fiber reinforcing layer and the second fiber reinforcing layer is a cord number per 1 inch in the width direction of the reinforcing cord.

TABLE 1

| | Conventional | | | | Comparative | Comparative | Comparative | Comparative |
|---|---|---|---|---|---|---|---|---|
| | example | Example 1 | Example 2 | Example 3 | Example 1 | Example 2 | Example 3 | Example 4 |
| Number of fiber reinforcing layer | 2 | 2 | 3 | 2 | 2 | 2 | 2 | 1 |
| (Sh portion in Outside) | | | | | | | | |
| Peeling strength of reinforcing | — | 108 | 108 | 108 | 108 | 93 | 108 | 108 |
| rubber layer | | | | | | | | |
| Half width (D1) of first | 100 | 100 | 100 | 100 | 100 | 100 | 100 | 100 |
| reinforcing fiber layer | | | | | | | | |
| Arrangement/width (D2) of | — | In/30 | In/30 | In/30 | Out/30 | In/30 | In/45 | In/30 |
| reinforcing rubber layer | | | | | | | | |
| Arrangement/width (D3) of second | Out/30 | Out/30 | Out/30 | Out/30 | In/30 | Out/30 | Out/30 | — |
| fiber reinforcing layer | | | | | | | | |
| End number of first fiber | 20 | 20 | 20 | 20 | 20 | 20 | 20 | 20 |
| reinforcing layer | | | | | | | | |
| End number of second fiber | 20 | 20 | 20 | 30 | 20 | 20 | 20 | 20 |
| reinforcing layer | | | | | | | | |
| High speed durability | 100 | 110 | 115 | 110 | 85 | 80 | 105 | 95 |
| Steering stability | 4 | 4 | 5 | 5 | 3 | 4 | 3 | 3 |

The examples 1 to 3 can well achieve both the durability and the steering stability in comparison with the conventional example and the comparative examples.

What is claimed is:

1. A pneumatic tire comprising:
a toroidal carcass layer which is provided between a pair of bead portions;
a belt layer which is arranged at an outer side in a tire diametrical direction of the carcass layer; and
a first fiber reinforcing layer which is arranged so as to cover both end portions of the belt layer at an outer side in the tire diametrical direction of the belt layer,
wherein a reinforcing rubber layer is arranged between the first fiber reinforcing layer and the belt layer at a shoulder portion at one side at which the shoulder portion is positioned at an inner side of the vehicle at the time of installing the tire, and a second fiber reinforcing layer is arranged in adjacent to the outer side or the inner side in the tire diametrical direction of the first fiber reinforcing layer at a shoulder portion at the other side at which the shoulder portion is positioned at the outer side of the vehicle, and
wherein a peeling strength of the reinforcing rubber layer is higher than a peeling strength of the belt layer and the first fiber reinforcing layer.

2. The pneumatic tire according to claim 1, wherein a width of the reinforcing rubber layer is equal to or less than one third of a half width of the first fiber reinforcing layer based on a tire equator.

3. The pneumatic tire according to claim 1, wherein a width of the second fiber reinforcing layer is equal to or less than one third of a half width of the first fiber reinforcing layer based on a tire equator.

4. The pneumatic tire according to claim 1, wherein the end number of the second fiber reinforcing layer is equal to or more than the end number of the first fiber reinforcing layer.
